(19) United States
(12) Patent Application Publication
(10) Pub. No.: US 2017/0042185 A1
(43) Pub. Date: Feb. 16, 2017

(54) JERKY TREATS

(71) Applicant: DogsWell, Los Angeles, CA (US)

(72) Inventors: Michael Bartley Green, Apple Valley, CA (US); Keith Edward Vohden, Redondo Beach, CA (US); Darin William Kleinsorge, Carl Junction, CA (US); Phillip Lee Huffman, Galena, KS (US); Donald Eugene Hill, Carl Junction, MO (US)

(21) Appl. No.: 14/824,005

(22) Filed: Aug. 11, 2015

(51) Int. Cl. A23K 10/20; A23K 50/42; A23N 17/00; A23K 40/20

(52) U.S. Cl. CPC A23K 10/20; A23K 40/20; A23K 50/42; A23N 17/005; A23N 17/002

(57) ABSTRACT

A method of producing a jerky dog treat, comprising, tumbling, under vacuum, a mixture comprising diced chicken, salt, and water for about 5 minutes, tumbling, under vacuum, the mixture further comprising one or more additional ingredients for about 15 minutes, molding the mixture into one or more strips comprising the jerky dog treat that are placed on a screen, and cooking the one or more strips in an oven.

### TECHNICAL FIELD

This disclosure generally relates to food intended for consumption by dogs, and more specifically relates to nutrient fortification for dogs.

### BACKGROUND

Dogs have sharp pointed teeth and short gastrointestinal tracts better suited for the consumption of meat. In spite of their natural carnivorous design, dogs thrive on both meat and non-meat food. It is estimated that over 50% of all dog owners regularly give their dogs treats. While treats are not essential to a dog's diet, treats are typically given to dogs as a way to indulge or train them.

Dog treats entered the market in the early 1900s. Commercially manufactured dog food, including dog treats, is now a multi-billion dollar industry. Manufacturers of dog treats have developed significant improvements in the production of dog treats, resulting in faster and more efficient production.

### BRIEF DESCRIPTION OF THE DRAWINGS

FIG. 1 illustrates an example machinery and equipment layout.

FIG. 2 illustrates another example machinery and equipment layout.

FIG. 3 illustrates an example machinery and equipment layout for packaging product.

FIG. 4 illustrates example formulas for jerky treat products.

FIG. 5 illustrates an example customized die.

FIGS. 6A-6B illustrate example quality testing parameters for finished product.

FIGS. 7A-7C illustrate different views of an example custom fill spout.

### DESCRIPTION OF EXAMPLE EMBODIMENTS

The present invention is now described in detail with reference to a few embodiments thereof as illustrated in the accompanying drawings. In the following description, numerous specific details are set forth in order to provide a thorough understanding of the present disclosure. However, the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to apply to alternatives, modifications, and equivalents as may be included within the spirit and scope of the disclosure as defined by the appended claims.

A jerky treat is a semi-hard, rectangular-shaped, strip product. Flavors or varieties may include chicken, beef, lamb, turkey, cheese, and bacon. In addition to various flavors, a jerky treat may be fortified with vitamins and minerals that are also essential to a healthy dog diet. The basic ingredients in a jerky treat are proteins, carbohydrates, water, fats and oils, and fiber. The ingredients used in jerky treats are specially tailored for dogs, and are chosen to be nutritious, easily digested, palatable, and economically feasible.

In addition to flavor variations, a jerky treat may be of different sizes, depending on the intended consumption by small to large dogs. Jerky treats may be packaged in a variety of packing technologies, including cardboard boxes, foil packaging, and plastic packaging.

The discussion below will describe product flow from a raw material stage to a packaged product being placed on a pallet prior to shipment. Machinery and equipment operating times, temperatures, and pressures are provided as ranges of times, temperatures, and pressures based on variations in the raw materials and the ambient conditions in the facility. Although controlled when possible, there may be variations in the chicken product, and the ranges allow optimized mixing and equilibration of the chicken product during preparation and prior to the dehydration stage. Operations may adjust mixing time to accommodate for type and temperature of raw chicken used in the process. The temperature ranges of the chicken pieces at the equilibration stage allow for any process deviations. The overall goal is to achieve consistent product and process conditions to optimize the dehydration cycle.

In particular embodiments, chicken jerky treats are produced using the various formulas utilizing white meat chicken breast and chicken tenders, chicken tender tops, chicken breast and tender trim in any combination of chicken. In particular embodiments chicken jerky treats utilize only chicken processed in U.S. Department of Agriculture (“USDA”) approved facilities to ensure a safe food quality. In particular embodiments, all raw materials must be from food-grade quality suppliers. Particular embodiments, chicken ingredients may be equal to or less than 5% fat content. In particular embodiments, the chicken may be maintained at 41° F. or less while processing and prior to placement in a cook oven.

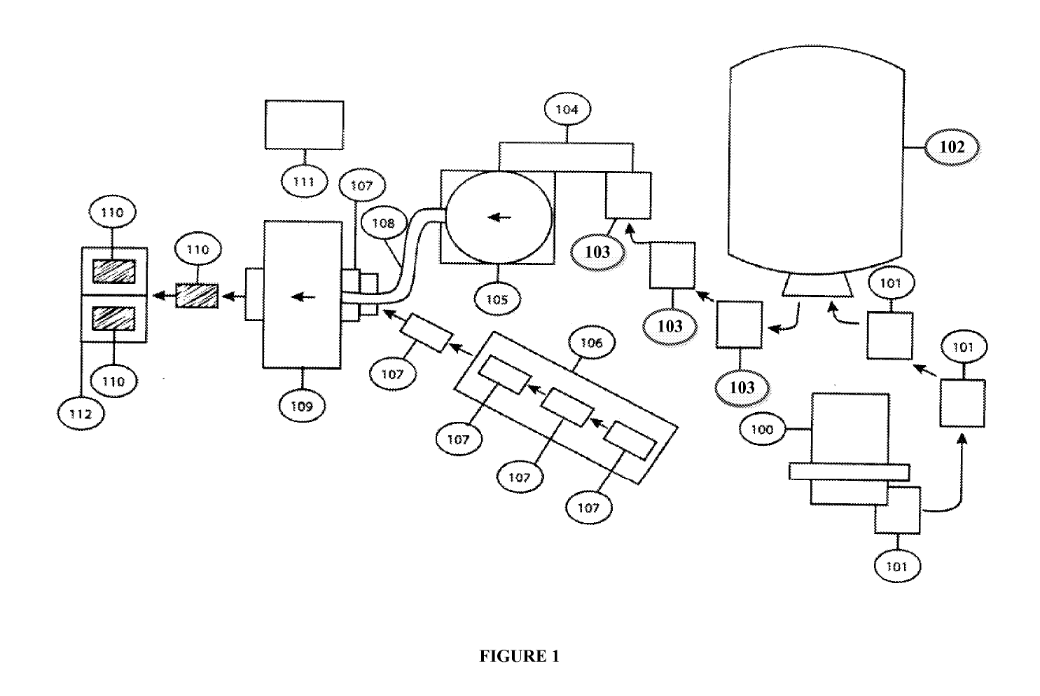

FIGS. 1-3 illustrate example layouts of machinery and equipment, and associated methods for processing jerky treats from raw material components into final packaged product for shipment. Particular embodiments may repeat any of the steps of the methods described in association with FIGS. 1-3, where appropriate. Moreover, although this disclosure describes and illustrates particular steps of the methods associated with FIGS. 1-3 as occurring in a particular order, the invention contemplates any suitable steps of the methods associated with FIGS. 1-3 occurring in any suitable order.

FIG. 1 illustrates an example layout of machinery and equipment, and a method for raw processing. In particular embodiments, chicken may be diced on dicer 100. In particular embodiments, dicer 100 may be a Carruthers AdvantEdge 12 inch 2D Dicer. In particular embodiments, chicken may be placed on the processing belt of dicer 100 in an even amount across the belt for dicing. In particular embodiments, chicken may be at 32-36° F. when placed into dicer 100. In particular embodiments, dicer 100 is set at ¾″ by ¾″ dice size and may dice the chicken to about ¾″ by ¾″ in diameter. In particular embodiments, a ¾″ by ¾″ dice size setting may give the product a structure that emulates a jerky style product. In particular embodiments, dicer 100 conveys diced chicken into chicken tote 101 that may be below dicer 100. In particular embodiments, a product net weight of the diced chicken may be measured by deducting the chicken tote 101 tare weights from the chicken tote 101 gross weight to get the chicken product net weight.

In particular embodiments, chicken and a brine solution may be tumbled in vacuum tumbler 102. In particular embodiments, vacuum tumbler 102 may be an AMFEC Vacuum Tumbler Model 175. In particular embodiments, vacuum tumbler may be utilized in a unique way to provide for a more complete blending of ingredients. A more complete blending of ingredients may be accomplished by a two-step tumbling procedure.

In particular embodiments, diced chicken may be added to tumbler 102 in a correct batch amount. In particular embodiments, a brine solution of salt and water may be prepared and added to the tumbler 102. In particular embodiments, the brine solution may be about 32-36° F. when it is added to the tumbler. Tumbler 102 may then commence a 4-8 minute tumbling process at 12 RPM with a vacuum of about 24-28 inches Hg vacuum. In particular embodiments, an optimum processing temperature for tumbling may be 32-36° F. During the tumbling process, salt binds proteins in the diced chicken and acts as a meat tenderizer. The vacuum pressure acts to pull the brine and additional ingredients into the diced chicken meat. The vacuum tumbling step allows the salt to begin breaking down the muscle fibers in the meat to soften its texture. Since there are no other ingredients to compete with the salt and meat, it allows for a reliable relaxation of the meat protein and a more complete inclusion of the remaining ingredients when a second vacuum tumbling step occurs.

In particular embodiments, chicken, the brine solution, and additional ingredients may be tumbled in tumbler 102. In particular embodiments, additional ingredients, such as water, sugar, glycerin, salt, glucosamine, chondroitin, vitamin E, flaxseed oil, and vitamin A may be added to the chicken and brine mixture in tumbler 102. Tumbler 102 may then commence a 12-18 minute tumbling process at 12 RPM with a vacuum of about 24-28 inches Hg vacuum. In particular embodiments, the high vacuum setting also supports the inclusion of the ingredients in the meat product.

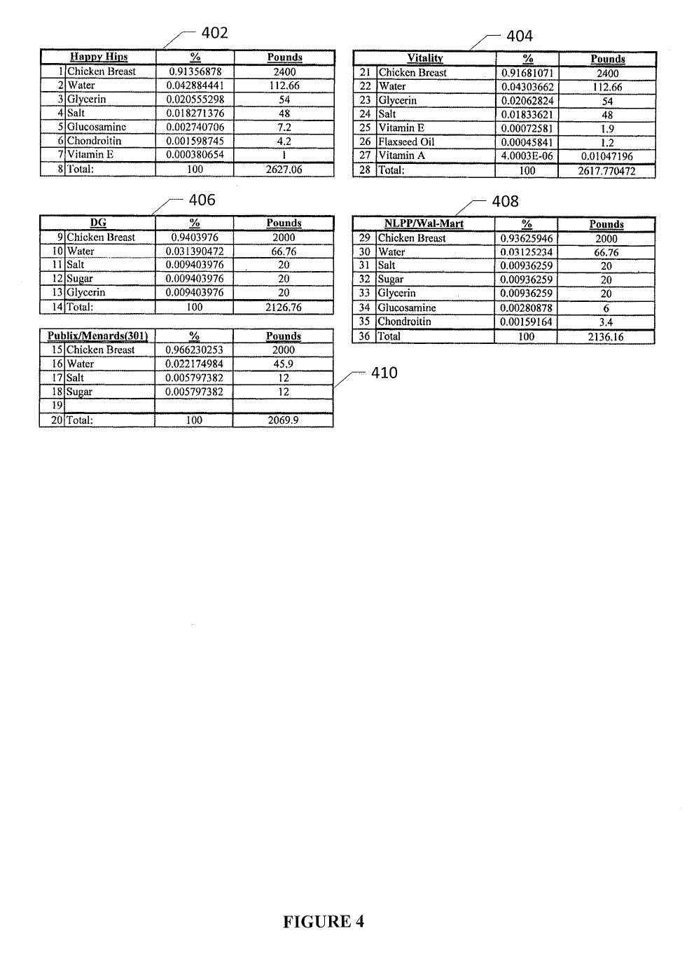

FIG. 4 illustrates example formulas for jerky treat products. In particular embodiments, there are five different formulas 402, 404, 406, 408, 410. Formulas 402, 404, 406, 408, 410 may vary on amount of an ingredient or may or may not contain a certain ingredient. Formulas 402, 404, 406, 408, 410 comprise a listing of ingredients by percent and by pounds.

In particular embodiments, following the tumbling process, the tackiness of the resulting product may be checked both visually and by hand. In particular embodiments, tumbler 102 may commence additional 2 minute tumbling process as needed until the desired tackiness level is achieved. In particular embodiments, the resultant tackiness is described as a protein extracted product that becomes pliable and relaxed with minimum rebound by using hand pressure.

In particular embodiments, the product, the fully combined ingredients, is discharged from tumbler 102 into bulk bin 103 for further processing. In particular embodiments, bulk bin 103 may be a stainless steel rolling cart.

In particular embodiments, the product may be transferred from bulk bin 103 into lifting arm 104. Lifting arm 104 may transfer product from bulk bin 103 into a pump 105. Pump 105 may be a Risco Pump Marel Model RS-505-CP. Pump 105 may automatically transfer product through hose 108 into portioner 109. Hose 108 may be a Townsend Connection Hose TRP 630. Portioner 109 may be a Revo Portioner Marel Model TRP 630.

In particular embodiments, screens 107 are placed on a conveyor belt of the portioner 109 from preparation table 106. Preparation table 106 may be a stainless steel preparation table or any kind of table capable of supporting one or more screens 107. Screens 107 may be stainless steel mesh screens suitable for baking product. In particular embodiments, screens 107 may be made of about 0.25-0.5 inch square mesh.

Screens 107 are clean from any debris and may be lightly coated with a release agent, such as mineral oil. In particular embodiments, screens 107 may be sufficiently coated with the release agent to completely cover the entire screen. Screens 107 coated in mineral oil may prevent product from sticking to the screens 107 during the cooking process, may allow some slight pull back from an original size, may reduce product size variability, that is, the final product may be slightly shorter and thicker after cooking if product does not stick to the screens during the cooking process, but not so short and thick that the product is of an inconsistent size, appearance, and texture, and may increase final product uniformity with respect to size, appearance, and texture.

In particular embodiments, mineral oil may be utilized as a processing aid that minimizes and virtually eliminates the sticking of the product on the cooking surface during the cooking process. The light spraying of mineral oil onto screens 107 prior to placement of the product on the screens eliminates product sticking to the screens during a cooking process. The light spraying of mineral oil onto screens 107 prior to placement of the product on the screens also allows for a clean crisp edge to develop during the cooking process, differentiating a final product from the competition. In particular embodiments, mineral oil is sprayed onto screens 107 by an airless system that atomizes the mineral oil into an even stream and coats screens 107 evenly. In particular embodiments, the mineral oil may by compliant with U.S. Pharmacopeial Convention (“USP”) standards, the National Formulary (“NF”) standards, Kosher, or some combination thereof. In particular embodiments, the mineral oil may have a viscosity of about 35 cSt to 420 cSt. In particular embodiments, a light food grade mineral oil may have lower viscosities of about 7 cSt to 30 cSt. In particular embodiments, the mineral oil may be Mineral Oil 70 white NF/Kosher with a viscosity of 3.1 at 100° C. In particular embodiments, the airless system that sprays mineral oil onto screens 107 may be operating at a pressure of about 1,800 psi.

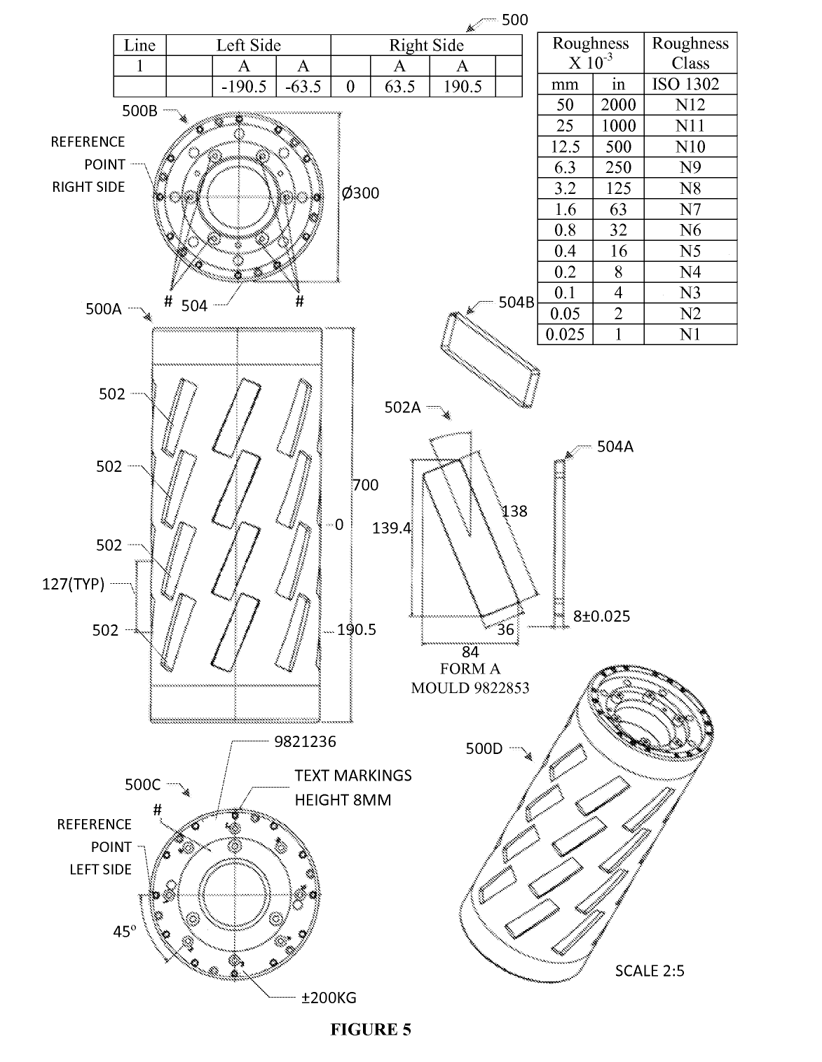

Portioner 109 distributes formed product onto the conveyorized screens 107, creating screens having formed product 110. In particular embodiments, portioner 109 may have a customized die instead of standard dies. In particular embodiments, a customized die may be a stick die. In particular embodiments, a customized die may be a formed die made of cintered (micro porous) stainless steel. FIG. 5 illustrates an example customized die 500. In particular embodiments, customizations may include rounding the edges on the stick die, which allows for faster release of the product from the die. In particular embodiments, customizations may include a dimensional change on the form die so that it creates a product with a more natural look and appeal. Varying perspectives of customized die 500 are illustrated in FIG. 5. Customized die 500A is a top view of customized die 500. In particular embodiments, customized die 500 has a 300 mm diameter and a 700 mm length. Customized die 500B is a right side view of customized die 500. Customized die 500C is a left side view of customized die 500. Customized die 500D is a top elevational view of customized die 500, showing customized die 500 at an angle and having side-depth. Forms 502 comprise indentations of various lengths, widths, and depths to form various jerky treat shapes. In particular embodiments, forms 502 comprise 138 mm length, 36 mm width, and 8 mm depth for strip engraving. In particular embodiments, forms 502 comprise 135.2 mm length, 61.8 mm width, and 8 mm depth for tender engraving. Forms 502A illustrates the angle of the embossing off center of parallel of the customized die. Forms 502, 502A are offset by an angle of 22.5° from center of customized die 500A. Product 504A illustrates a side vide of jerky treat product that comes off of forms 502. Product 504B illustrates a top elevational view of jerky treat product that comes off of forms 502 to show that each jerky treat product has a length, width, and depth.

Screens having formed product 110 comprise one or more strips of product per screen. In particular embodiments, portioner 109 employs a unique process for orienting the formed jerky product onto the trays. This allows for increased definition of the product by not allowing overlapping, curling, or twisting of the product prior to a cooking step. In particular embodiments, portioner 109 distributes a flat uniform product by even placement, which is required by the design of the tray device. In particular embodiments, piece placement on a surface of screen 107 is controlled by adjusting variable settings on portioner 109. In particular embodiments, piece dimensions and profile are determined by the design of a customized die roll, such as the customized die illustrated in FIG. 5.

Screens having formed product 110 are placed onto a screen truck 112 for placement into a processing oven. In particular embodiments, screen truck 112 may be a stainless steel racking system. In particular embodiments, screen truck 112 may hold about 44 screens having formed product 110.

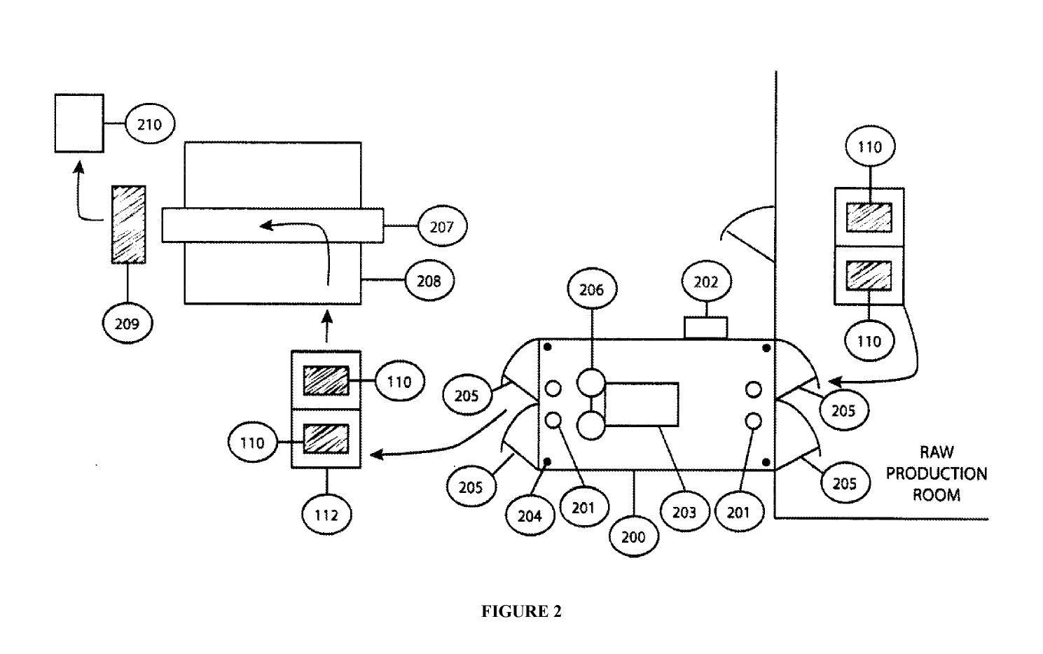

FIG. 2 illustrates an example layout of machinery and equipment, and a method for oven and screen loading and unloading. In particular embodiments, 8 screen trucks 112 are loaded into an oven 200 and the doors are closed. An oven 200 may be a Marlen Thermal Processing Oven, such as models SC23510001 and SC23510001-1. In particular embodiments, particular components of oven 200 include, but are not limited to, damper 201, computer 202, gas train 203, temperature probe 204, oven doors 205, and oven exhaust 206.

In particular embodiments, processing of the product may start by engaging the computer 202 that controls the oven, such as a PC6000. In particular embodiments, a cooking method for a chicken jerky product comprises an equilibrium process and a cooking process. In particular embodiments, a cooking method may follow a pre-programmed path that regulates the relative humidity percentage (“% RH”), time, and temperature automatically. In particular embodiments, a cooking method comprises steps 1-13 in Table 1:

| | Type | Event | Time | Int | Dry | Wet | RH % | Smoke | Dwell | Damper | Options | Fan | Comment |
|---|---|---|---|---|---|---|---|---|---|---|---|---|---|
| 1 | COOK | 5 | 40 | 0 | 135 | 110 | 45 | NONE | 0 | AUTO | 1 | 100 | |
| 2 | COOK | 5 | 30 | 0 | 155 | 126 | 43 | NONE | 0 | AUTO | 1 | 100 | |
| 3 | COOK | 5 | 240 | 0 | 172 | 147 | 53 | NONE | 0 | AUTO | 1 | 100 | |
| 4 | COOK | | 15 | 0 | 170 | 142 | 48 | NONE | 0 | AUTO | 1 | 100 | |
| 5 | COOK | | 15 | 0 | 168 | 137 | 43 | NONE | 0 | AUTO | 1 | 100 | |
| 6 | COOK | | 15 | 0 | 166 | 132 | 39 | NONE | 0 | AUTO | 1 | 100 | |
| 7 | COOK | | 15 | 0 | 164 | 127 | 35 | NONE | 0 | AUTO | 1 | 100 | |
| 8 | COOK | | 15 | 0 | 162 | 122 | 31 | NONE | 0 | AUTO | 1 | 100 | |
| 9 | COOK | | 15 | 0 | 160 | 117 | 28 | NONE | 0 | AUTO | 1 | 100 | |
| 10 | COOK | | 15 | 0 | 158 | 112 | 24 | NONE | 0 | OPEN | 1 | 100 | |
| 11 | COOK | | 15 | 0 | 156 | 107 | 21 | NONE | 0 | OPEN | 1 | 100 | |
| 12 | COOK | | 15 | 0 | 154 | 102 | 17 | NONE | 0 | OPEN | 1 | 100 | |
| 13 | COOK | | 105 | 0 | 152 | 0 | 0 | NONE | 0 | OPEN | 1 | 100 | |

In particular embodiments, a cooking method comprises steps 1-13 in Table 1 above, including one or more detailed parameters or controls that are utilized during the cooking method. In particular embodiments, one or more detailed parameters comprise an event. An event may comprise: (1) accelerated datalog; (2) internal deviation; (3) reverse internal; (4) refrigeration dry; (5) refrigeration wet; (6) fan on; (7) intermittent fan; and (8) intermittent shower. In particular embodiments, one or more detailed parameters comprise type, time, int, dry, wet, % RH, smoke, dwell, damper, options, fan, and comment. Time may comprise the time at each step. Dry may comprise a temperature to be achieved within the oven. Options may comprise: (0) open damper; (A) auto damper; (C) closed damper; (H) humidity; (1) output 1; (2) output 2; (3) output 3; (*) hold and maintain; (#) hold and minimize; and ($) hold and pause.

In particular embodiments, the entrance dampers are closed and the exit-end dampers are open on an oscillating damper. In particular embodiments, damper control is a unique cooking technique that may ensure more uniform air flow over the product in the oven, which may result in a more even cooking of the product regardless of where it is positioned inside the oven.

In particular embodiments, an equilibrium process comprises bringing the internal product temperature to between 105° F. and 120° F., and preferably to 110° F., within the entire product within the oven over a 38-45 minute dwell time. Prior to a final cook step, an equilibration process occurs once the product is introduced into the enclosed Marlen Thermal Processing Oven. An equilibrium procedure is important because: (1) it allows time for the nutrients to reabsorb in the product following product formation; (2) it increases the total time that the salt interacts with the protein of the meat, which creates a more tender and flavorful product; and (3) it allows time for the moisture in the recently formed product to distribute evenly within the product, which eliminates hot spots and cold spots during higher temperature cooking and prevents burn marks from appearing on the final cooked product.

In particular embodiments, an equilibrium process relaxes the product prior to cooking and improves the finished product's organoleptic properties. This may be exhibited by the uniform color of the finished product. In particular embodiments, an equilibrium process may improve the tenderness, aroma, and flavor of the product. In particular embodiments, an equilibrium process may allow for a more consistent cook cycle of the entire product in the 35 ft. long oven. In particular embodiments, an equilibrium process may increase the consistency of the size and uniformity of the final cooked product.

In particular embodiments, a cooking process includes a thermal kill step or heat kill step where the oven reaches a minimum temperature of 142° F. for at least 60 minutes.

In particular embodiments, follow the cooking method, screen trucks 112 are removed from the oven and the product is weighed. In particular embodiments, quality testing may be performed on randomly selected samples of product. In particular embodiments, quality testing may include water activity. Water activity should be maintained between about 0.60 and 0.72.

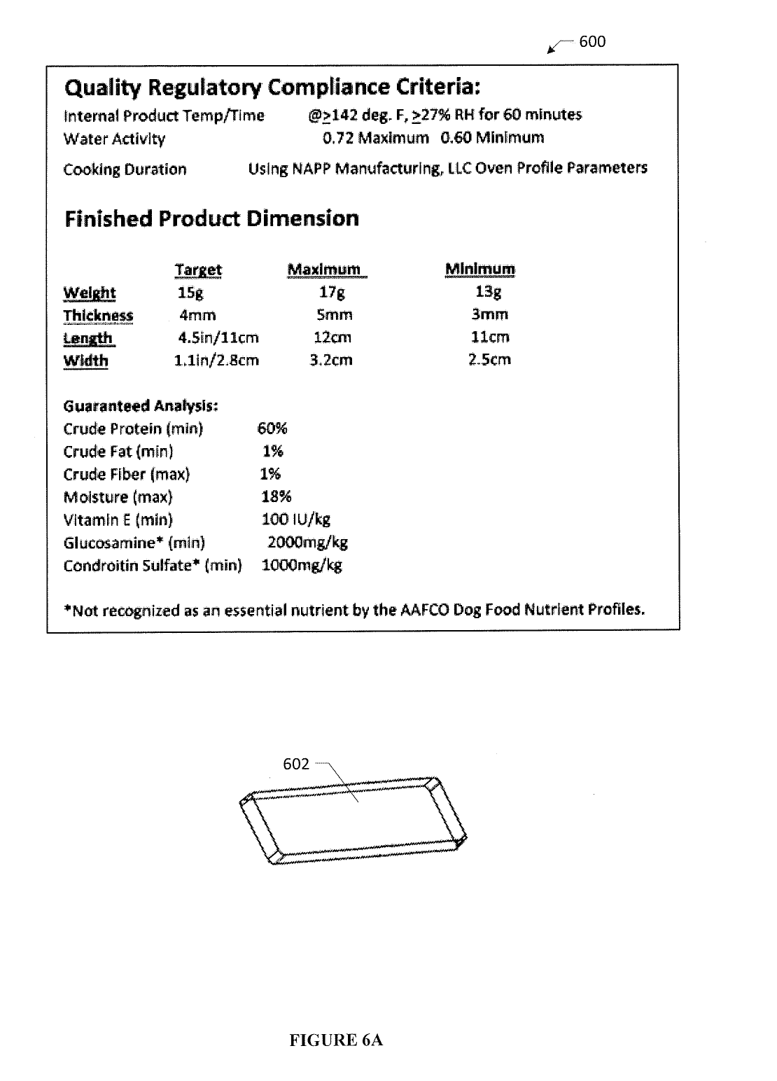

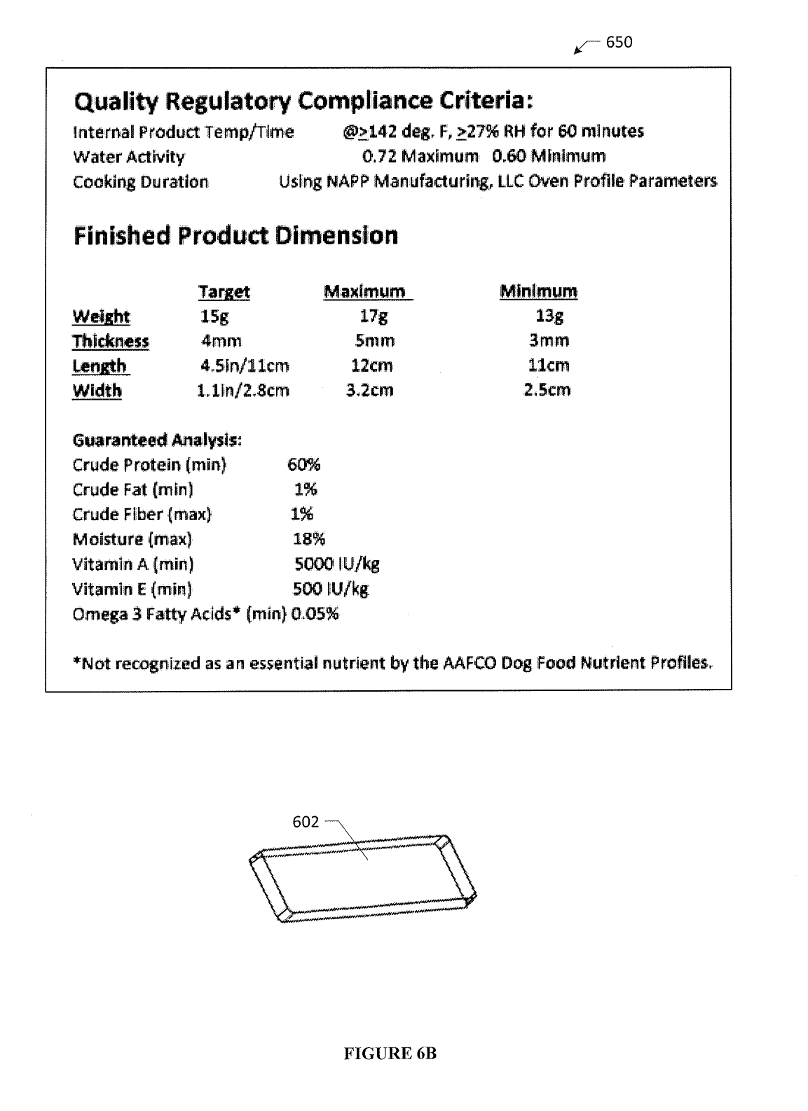

In particular embodiments, product that has passed quality testing may be released for visual sorting. Screens with product 110 may be placed on screen unload table 208. Product may then be removed from screens with product 110, and the product placed on screen unload conveyor 207. In particular embodiments, any non-conforming product is removed from final conforming product. Final conforming product is placed in sack 210. Sack 210 may be a Super Sack™. In particular embodiments, once visually conforming product is placed in sack 210, additional quality testing may be performed, such as the quality parameters illustrated in FIGS. 6A and 6B. FIG. 6A illustrates example quality regulatory compliance criteria 600 for finished product containing Vitamin E, Glucosamine, and Condroitin Sulfate. FIG. 6B illustrates example quality regulatory compliance criteria 650 for finished product containing Vitamin A, Vitamin E, and Omega 3 Fatty Acids. Quality regulatory compliance criteria 600, 650 include finished product dimension, internal product temperature and time, water activity, cooking duration, guaranteed analysis of components, and an illustration of final product 602.

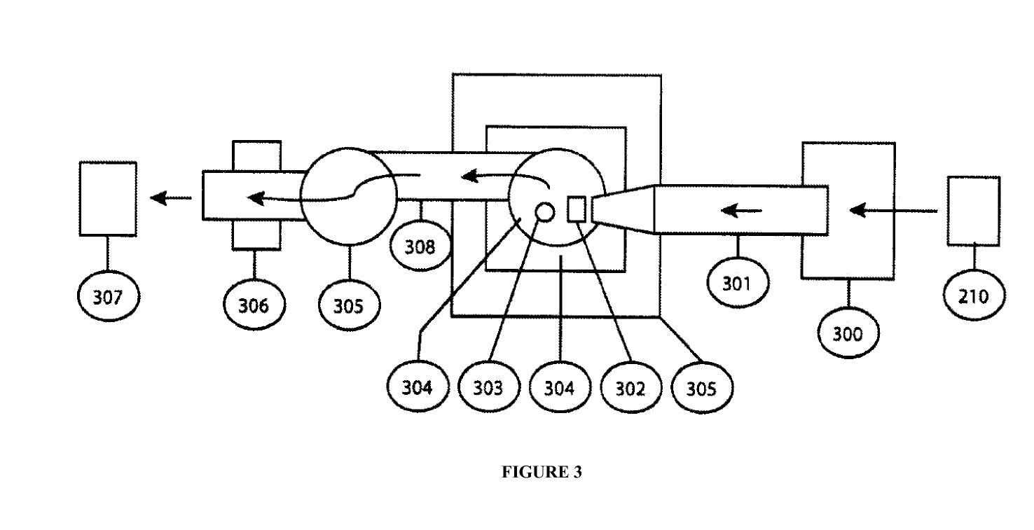

In particular embodiments, once all quality testing parameters are met for the final product; the product may be released for packaging. FIG. 3 illustrates an example machinery and equipment layout for packaging final product.

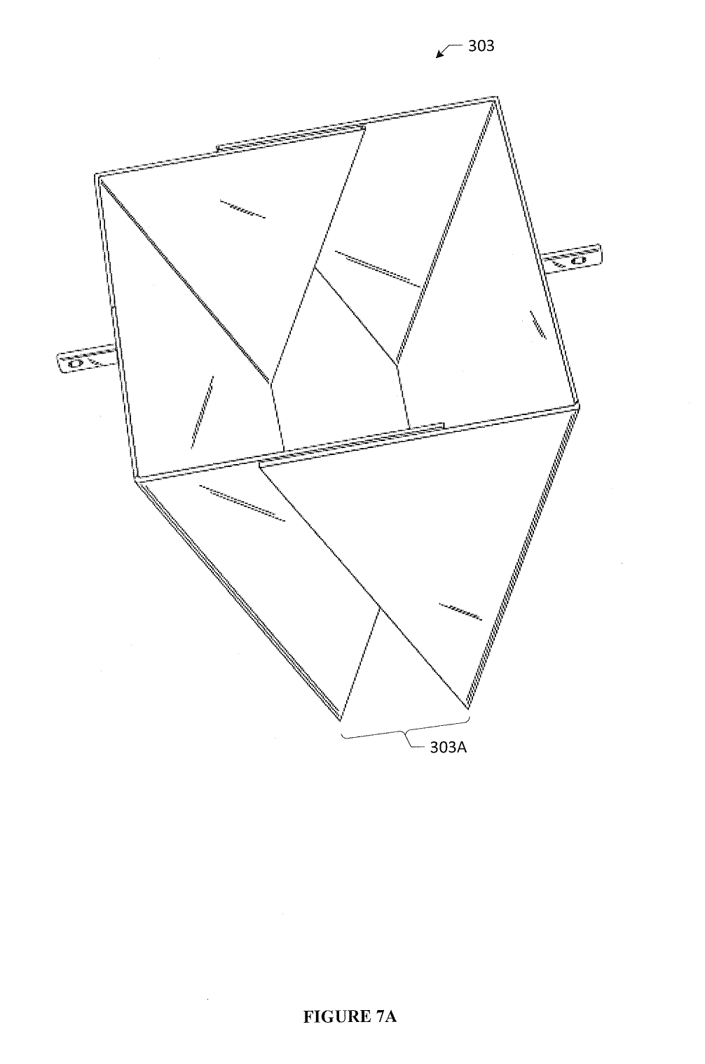

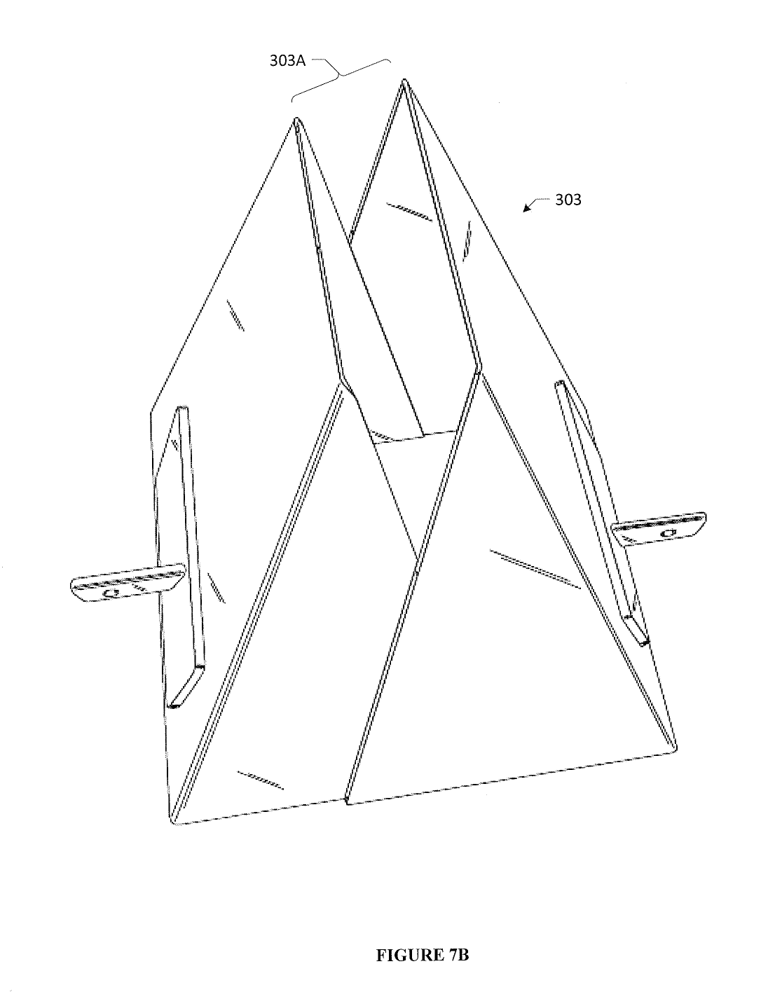

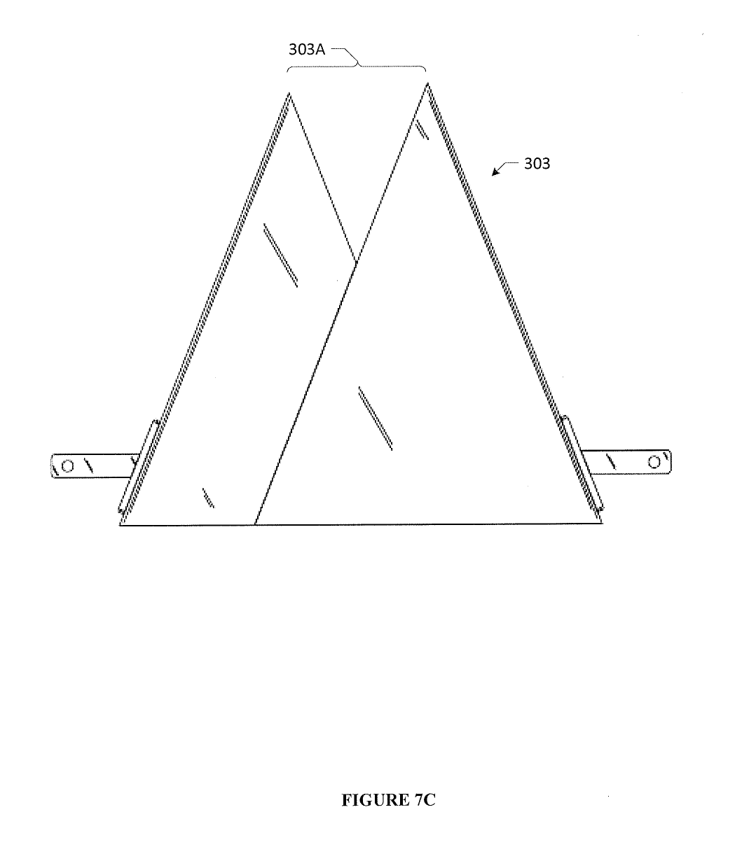

In particular embodiments, contents of sack 210 are placed into hopper 300. Hopper 300 may be a stainless steel hopper. From hopper 300, products are introduced to a conveyor 301. Conveyor 301 may be a VWM incline conveyor. In particular embodiments, hopper 300 and conveyor 301 feed the product through a metal detector 302 prior to distribution and packaging. Metal detector 302 may be a Safe Line Metal Detector. Hopper 300 and conveyor 301 feed the product in an evenly distributed flow into scale-filler 304 and fill spout 303, which both reside above rotating accumulation table 305. In particular embodiments, scale-filler 304 is a Yamato RP-6TZE 14 Bucket scale and bag filler with an attached spout 303, which may be a custom made fill spout 303, such as the fill spout illustrated in FIGS. 7A-7C.

FIG. 7A illustrates a top elevation view of an example custom fill spout 303. FIG. 7B illustrates a bottom elevation view of an example custom fill spout 303. FIG. 7C illustrates a side view of an example custom fill spout 303. In particular embodiments, fill spout 303 is of a clamshell design of about an 8″×8″×11″ configuration. In particular embodiments, the fill lip opening 303A on the end varies in width depending on the weight of the product. In particular embodiments, fill spout 303 eliminates jamming in the articulating sides of the fill spout. In particular embodiments, fill spout 303 eliminates the tendency of the product to bridge over the fill hole, which can under fill the bag.

In particular embodiments, product may be packaged into cardboard or plastic boxes, or plastic bags by scale-filler 304. Once packaged, packaged product proceeds along discharge conveyor 308 to another rotating accumulation table 305, and into box taper 306, where finished product 307 is generated. Box taper 306 may be a manual or automated box taper. In particular embodiments, box taper 306 may be a BEL WFPS 5150 box taper. Finished product 307 is placed onto a clean 40 inch by 48 inch pallet and placed in a warehouse for shipment.

1. A method of producing a jerky dog treat, comprising:
tumble, under vacuum, a mixture comprising diced chicken, salt, and water for about 5 minutes;
tumble, under vacuum, the mixture further comprising one or more additional ingredients for about 15 minutes;
mold the mixture into one or more strips comprising the jerky dog treat that are placed on a screen; and
cook the one or more strips in an oven.

2. The method of claim, 1 further comprising package the cooked strips into a container.

3. The method of claim 1, wherein the vacuum comprising a vacuum of about 24-28 inches Hg.

4. The method of claim 1, wherein the one or more additional ingredients comprise one or more of glycerin, sugar, glucosamine, chondroitin, vitamin E, vitamin A, and flaxseed oil.

5. The method of claim 1, wherein the screen is coated in a thin layer of a release agent.

6. The method of claim 5, wherein the release agent was applied to the screen using a pressure sprayer.

7. The method of claim 5, wherein the release agent is mineral oil.

8. The method of claim 1, wherein cook the one or more strips in an oven comprises a two-step cooking process, including an equilibrium step and a heat kill step.

9. The method of claim 8, wherein the equilibrium step comprises bringing an internal temperature of the one or more strips up to between 105° F. and 120° F. and having a duration of 40 minutes.

10. The method of claim 9, wherein the internal temperature of the one or more strips is 110° F.

11. A system for producing a jerky dog treat, comprising:
a means for tumbling under vacuum for about 5 minutes, a first mixture comprising diced chicken, salt, and water;
another means for tumbling under vacuum for about 15 minutes, a second mixture comprising the first mixture and one or more additional ingredients;
a means for molding the second mixture into one or more strips comprising the jerky dog treat and placing the one or more strips onto a screen; and
a means for cooking the one or more strips.

12. The system of claim 11, further comprising a means for packaging the cooked strips into a container.

13. The system of claim 11, wherein the means for tumbling under vacuum operates a vacuum of about 24-28 inches Hg.

14. The system of claim 11, wherein the one or more additional ingredients comprise one or more of glycerin, sugar, glucosamine, chondroitin, vitamin E, vitamin A, and flaxseed oil.

15. The system of claim 11, wherein the screen is coated in a thin layer of a release agent.

16. The method of claim 15, wherein the release agent was applied to the screen using a pressure sprayer.

17. The system of claim 15, wherein the release agent is mineral oil.

18. The system of claim 11, wherein the means for cooking the one or more strips executes a program that is operable to equilibrate the one or more strips and heat kill the one or more strips.

19. The system of claim 18, wherein the equilibration comprises bringing an internal temperature of the one or more strips up to between 105° F. and 120° F. and having a duration of 40 minutes.

20. The system of claim 19, wherein the internal temperature of the one or more strips is 110° F.
